(19) United States
(12) Patent Application Publication
(10) Pub. No.: US 2006/0021166 A1
(43) Pub. Date: Feb. 2, 2006

(54) Electric toothbrush

(76) Inventor: Craig Hills, Keilor Downs (AU)

Correspondence Address: FASTH LAW OFFICES (ROLF FASTH), 26 PINECREST PLAZA, SUITE 2, SOUTHERN PINES, NC, 28387-4301, US

(21) Appl. No.: 11/226,546

(22) Filed: Sep. 14, 2005

Related U.S. Application Data
(63) Continuation-in-part of application No. PCT/AU04/00320, filed on Mar. 17, 2004.

(30) Foreign Application Priority Data
Mar. 17, 2003 (AU) 2003901241
Mar. 17, 2003 (AU) 2003901242
Mar. 17, 2003 (AU) 2003901243
Mar. 17, 2003 (AU) 2003901244

(51) Int. Cl. A61C 17/26

(52) U.S. Cl. 15/23

(57) ABSTRACT

An electric toothbrush includes a brush head that has a plurality of tooth engaging elements, such as bristles and polishers optionally arranged in alternating rows on the brush head. The brush head is driven by an elongate drive shaft connected to drive means typically located in the handle or body portion of the toothbrush. The driveable toothbrush attachment and the handle or body portion are separate modular units. The brush head is operable to slowly rotate (at say, between 60 and 240 rpm), about an axis substantially corresponding to the longitudinal axis of the drive shaft.

### PRIOR APPLICATIONS

This is a continuation-in-part application of PCT/AU2004/000320, filed 17 Mar. 2004 that claims priority from Australian patent application nos. 2003901241, 2003901242, 2003901243, 2003901244 all filed on 17 Mar. 2003.

### FIELD OF INVENTION

This invention relates to electric toothbrushes. More particularly, this invention relates to electric toothbrushes with rotatable toothbrush heads and methods of brushing teeth using the same.

### BACKGROUND OF THE INVENTION

Electric toothbrushes are known as dental maintenance devices. The electric toothbrush typically includes a detachable shaft with a small head. The small head includes a brush mounted for oscillation about an axis transverse to the shaft. In these prior electric brushes, the brush is configured to move rapidly in a reciprocating arcuate motion and performs primarily as a gum massager, rather than an effective toothbrush capable of removing debris and/or plaque from the user's teeth. Rotating electric toothbrushes have been proposed but are not known to be effective.

It is an object of the present invention to provide a rotating electric toothbrush which can be effective to brush and clean a user's teeth.

It is a further object of the present invention to provide a rotating electric toothbrush which can be capable of use with minimal or no or reduced damage or irritation to gums.

It is a further object of the present invention to provide a method of effectively using a rotating electric toothbrush to brush and clean a user's teeth.

### SUMMARY OF THE INVENTION

According to one aspect of the invention, there is provided an electric toothbrush having a handle with a drive therein and switch means for controlling operation of the drive, and a driveable toothbrush attachment which include a brush head having a plurality of tooth engaging elements, the brush head operably engaging an elongate drive shaft which is operably associated with the drive so as to be drivingly rotated thereby, wherein the drive operates to rotate the brush head at a rotational speed of between 60 and 240 revolutions per minute (rpm.) about an axis substantially corresponding to the longitudinal axis of the drive shaft.

In one preferred aspect there is provided an electric toothbrush having a driveable toothbrush attachment including a brush head having a plurality of tooth engaging elements, such as bristles and polishers optionally arranged in alternating rows on the brush head, the brush head adapted to operably engage an elongate drive shaft for connection to drive means typically located in the handle or body portion of a toothbrush unit, the driveable toothbrush attachment and the handle or body portion being separate modular units, wherein the brush head is operable to slowly rotate (at say, between 60 and 240 rpm), about an axis substantially corresponding to the longitudinal axis of the drive shaft.

The drive shaft may be housed in an elongate sheath whereby the user's soft buccal cavity tissue is not exposed to the rotating drive shaft. The brush head may include a head shaft contiguous with the drive shaft. The head shaft may be engageable to the drive shaft. The head shaft may be integrally formed with the drive shaft. Preferably, the head shaft is non-releasably attachable to the drive shaft to reduce the possibility of the brush head separating from the drive shaft during use thereby posing a potential choking danger to the user.

The drive shaft may be flexible and may comprise a flexible metal wire or polymer rod. The drive shaft may comprise a metal or polymeric cable, optionally comprising a plurality of strands for increased strength and flexibility. Alternatively, the drive shaft may be rigid and may comprise a metal shaft or a polymeric shaft made from high strength material. The person skilled in the art will appreciate that the drive shaft may be made from any material found to be suitable in the corresponding component of driven toothbrushes of the prior art.

The driveable toothbrush attachment may include guard means to protect the soft tissue of the user's buccal cavity. The guard means may include a cover located on one side of the brush head leaving the user's teeth exposed on the other side to the tooth engaging elements. The guard means may be hinged, for example to the sheath so that the brush head may be more thoroughly cleaned. The guard means may be completely removable for applications where it is considered unnecessary. However, preferably, the guard means is non-releasably engaged to the attachment or to the sheath to reduce the dangerous possibility of the guard means becoming separated in the buccal cavity and thereby presenting a choking hazard.

The speed of the rotational motion of the brush head is between 30 and 600 revolutions per minute (rpm), preferably between 60 and 240 rpm. Preferably, the speed of the brush head is in the lowest third of this range, i.e. between 60 and 150 rpm and most preferably about 100 rpm. The slow rotational motion of the brush head advantageously improves the brushing action of the brush head and distinguishes the invention from prior art oscillating/vibrating brush heads which effectively operate as gum massagers, rather than effective tooth brushing devices. Also these slow speeds minimise or avoid gum damage if the rotational direction carries the brush elements from the distal or free ends of the teeth into contact with the gums. Higher speeds can cause centrifugal discharge of particulates. The tooth engaging elements may include a variety of different types of elements. Preferably, the tooth engaging elements comprise a plurality of bristles and a plurality of polishers. The bristles may be effective to brush the teeth and the polishers effective to clean and polish the teeth. The bristles and polishers may be located in alternating rows on the brush head. The alternating rows may be aligned along the length of the brush head. Preferably, the alternating rows are arranged parallel to the longitudinal axis of the brush head.

Preferably, the brush head includes a head shaft on which the tooth engaging elements are mounted. The cross-section of the head shaft may be uniform along its length. Alternatively, the cross-section of the head shaft may vary such that the head shaft is tapered at one or both ends to improve the comfort of the user. The brush head cross-section may be polygonal whereby the head shaft includes a plurality of elongate flat faces spaced radially from its longitudinal axis. The brush head cross-section may be hexagonal or octagonal. The alternating rows of bristles and polishers may extend along the elongate faces. This arrangement is advantageous for ease and cost of manufacture as each type of tooth engaging element may be mounted on each corresponding elongate face in a simplified process. The process for mounting the tooth engaging elements on the head shaft include forming apertures in the head shaft to receive the tooth engaging elements either by forming bores or, preferably, by forming the apertures in an injection moulding process, inserting the tooth engaging elements into the apertures and fusing the tooth engaging elements into place by heat welding, ultrasonic welding or other methods known to the skilled person in the art.

The basic toothbrush unit may include a handle housing a rechargeable battery source and an electric motor. Desirably, the attachment is releasably connectable to the existing unit via the attachment of the elongated drive shaft and sheath to the existing unit. As the typical toothbrush electric motor available in the marketplace prior to this invention was a small high speed motor capable of running at speeds of 6000 rpm, the rotational speed must be modified by a gearing system to translate the high speed rotation of the electric motor to low speed rotation of the brush head. Alternatively, a slow speed electric motor may be employed.

One or more types of the tooth engaging elements may be inclined to normal relative to the longitudinal axis of the head shaft. Preferably, the bristles are inclined 10° to normal relative to the axis of rotation of the head shaft.

In another aspect there is provided a driveable toothbrush attachment including:
(a) a brush head including:

(i) a head shaft having a cross-section which is polygonal in shape; and

(ii) alternate rows of bristles and polishing tooth engaging elements located along the flat surfaces of the head shaft; and
(b) an elongate housing adjacent the brush head including an elongate drive shaft adapted to operably engage the brush head,

wherein the brush head undergoes rotational motion at a speed of between 60 and 240 rpm about an axis substantially co-axial with the drive shaft.

According to a further aspect of the invention there is provided a method of cleaning a user's teeth, the method comprising: providing an electric toothbrush with a handle having a drive therein, switch means for controlling the operation of the drive, and a driveable toothbrush attachment extending outwardly and away from the handle in a longitudinal direction, the attachment including a brush head having a plurality of tooth engaging elements, the brush head being driven by the drive within the handle so as to rotate about an axis substantially corresponding to the longitudinal axis of the attachment, applying the brush head to the user's teeth, and operating the switch means to power the drive within the handle so that the drive rotates the brush head at a rotational speed sufficiently low so as to avoid the teeth engaging elements pushing the user's gums backwardly from the teeth if the brush head is applied to the user's teeth with the rotational direction being from the distal or free ends of the teeth and towards the gums, that rotational speed being in the range 60 and 240 rpm.

### BRIEF DESCRIPTION OF THE DRAWINGS

Possible and preferred features of the present invention will now be described with particular reference to the accompanying drawings. However, it is to be understood that the features illustrated in and described with reference to the drawings are not to be construed as limiting on the scope of the invention. In the drawings:

FIG. 1a is a schematic side view of a toothbrush incorporating a driveable toothbrush attachment according to a first embodiment of the invention;

FIG. 1b is an underneath view of a toothbrush having a different toothbrush attachment and a different location and configuration of control switches;

FIG. 2a is a perspective view of a second embodiment of a brush head;

FIG. 2b is a side view of the brush head shown in FIG. 2a;

FIG. 2c is a side view of the toothbrush with a guard;

FIG. 2d is a detailed view of the toothbrush that has a hood;

FIG. 3a is a perspective view of a third embodiment of a brush head;

FIG. 3b is a side view of the brush head shown in FIG. 3a;

FIG. 3c is a side view of the toothbrush with a guard;

FIG. 3d is a detailed view of the toothbrush that has a hood;

FIG. 4a is a perspective view of a fourth embodiment of a brush head;

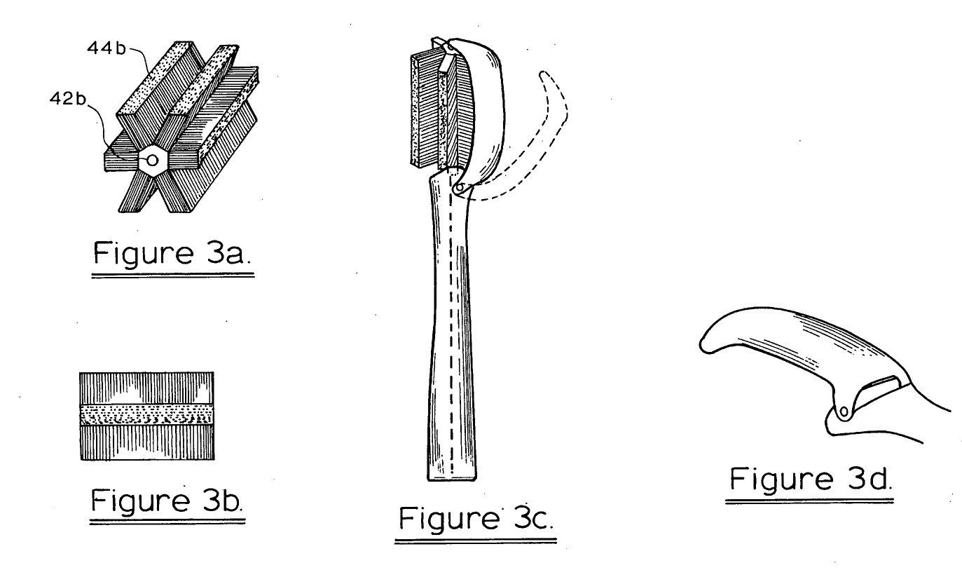

FIG. 3b is a side view of the brush head shown in FIG. 3a;

FIG. 3c is a side view of the toothbrush with a guard;

FIG. 3d is a detailed view of the toothbrush that has a hood;

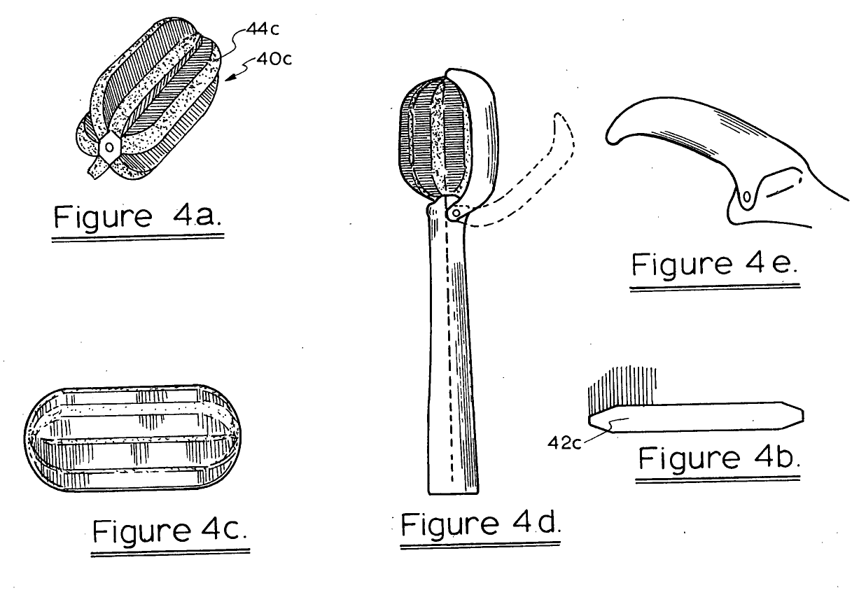

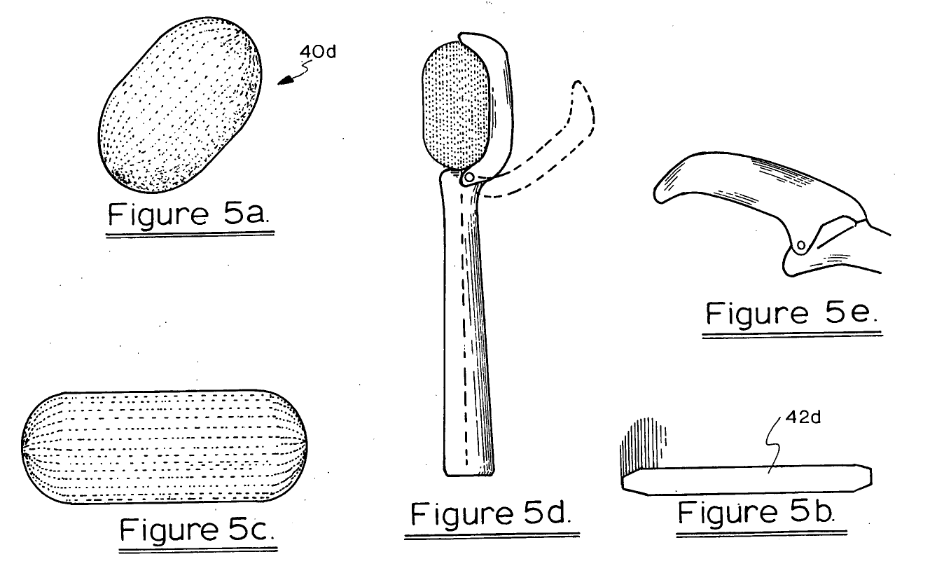

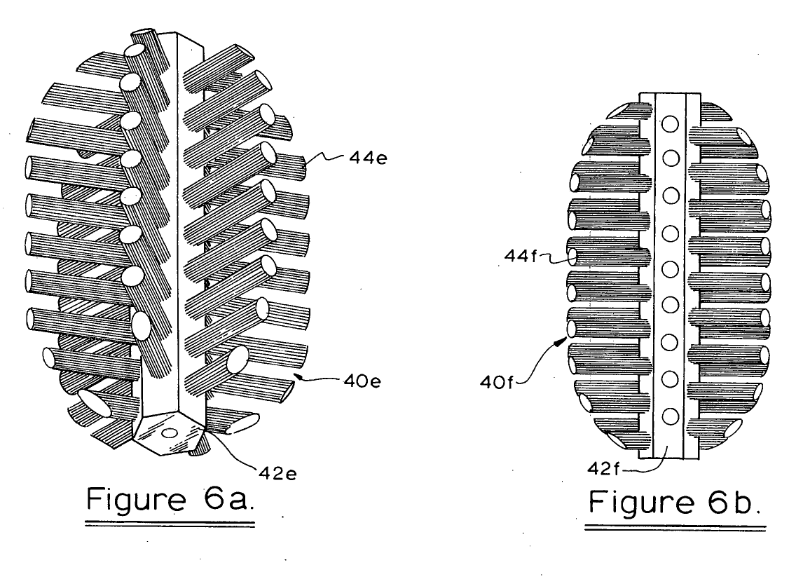

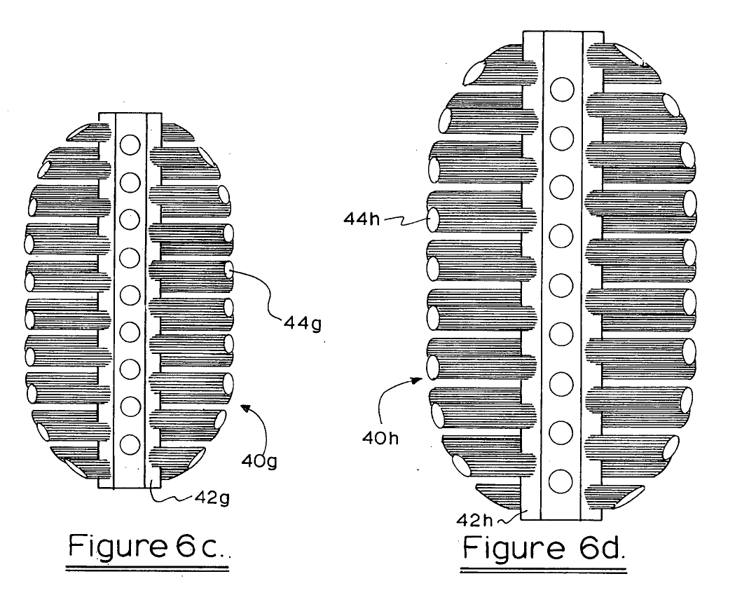

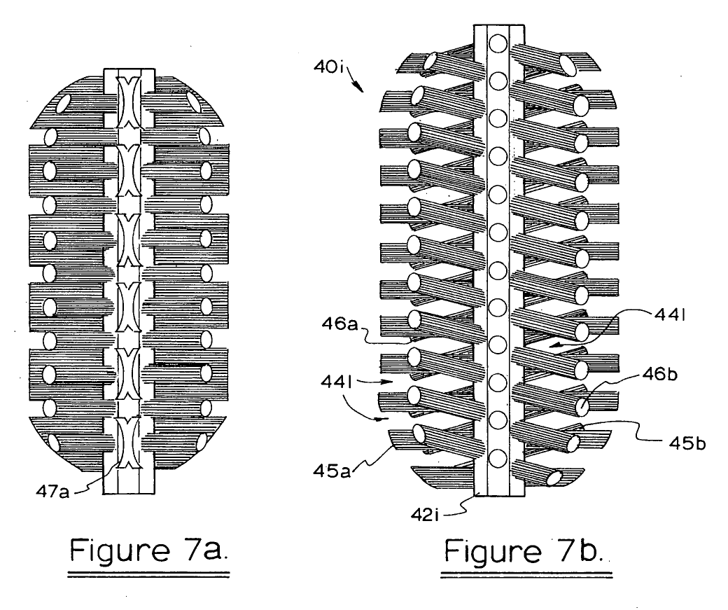

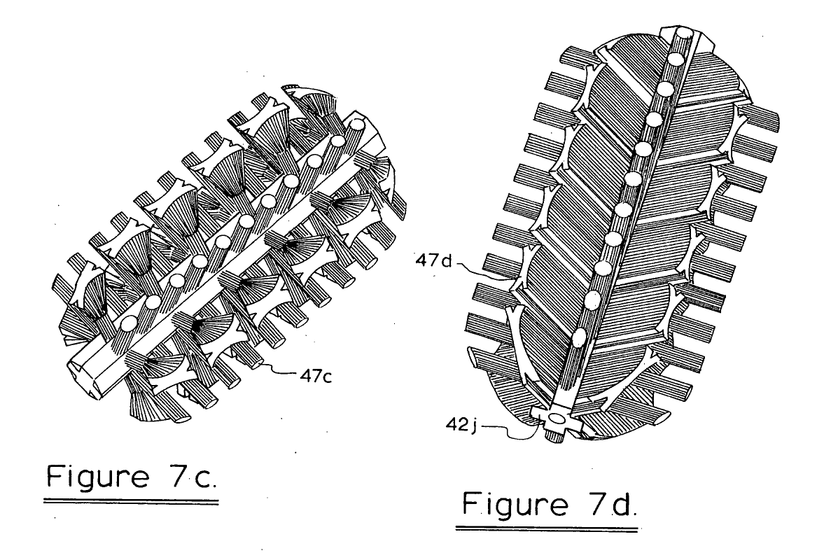

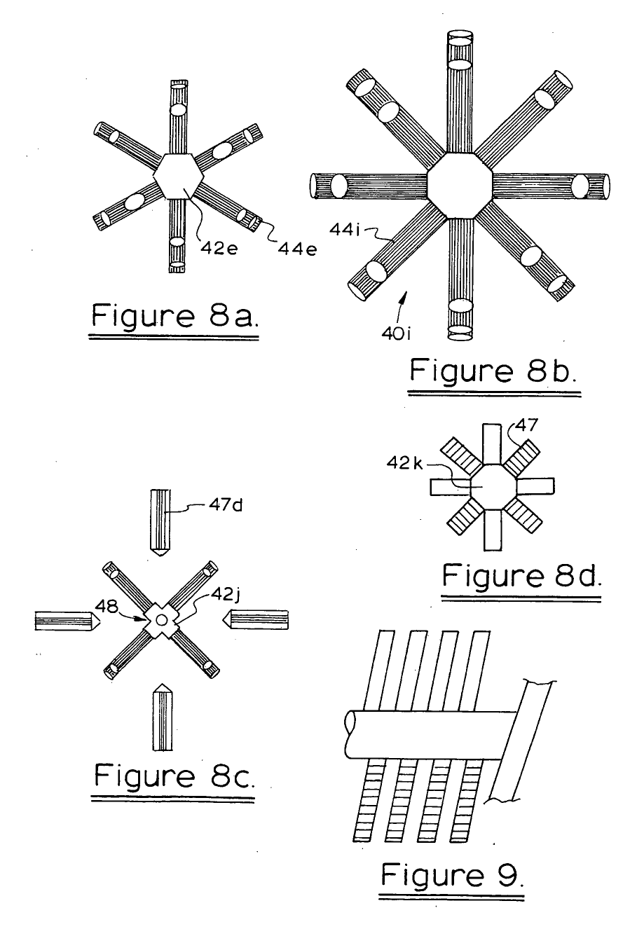

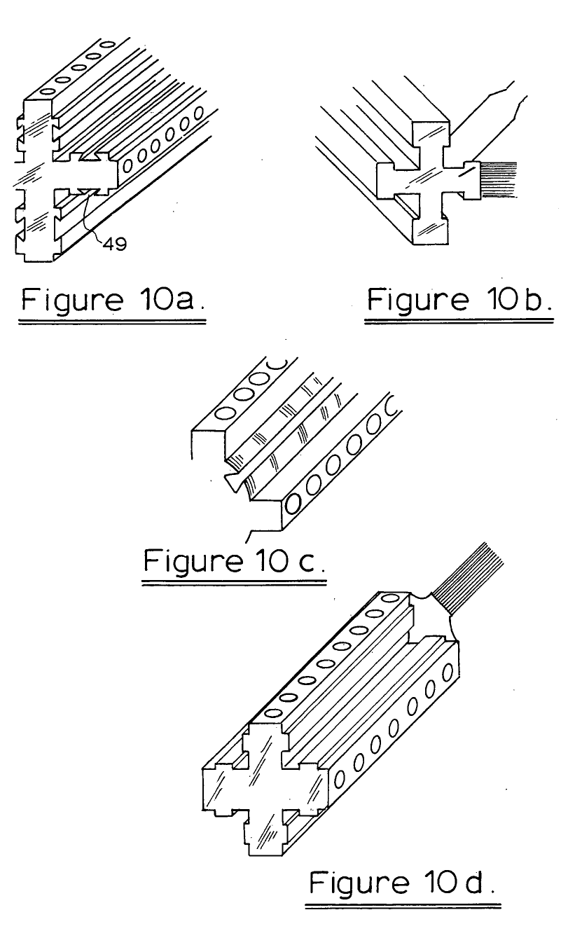

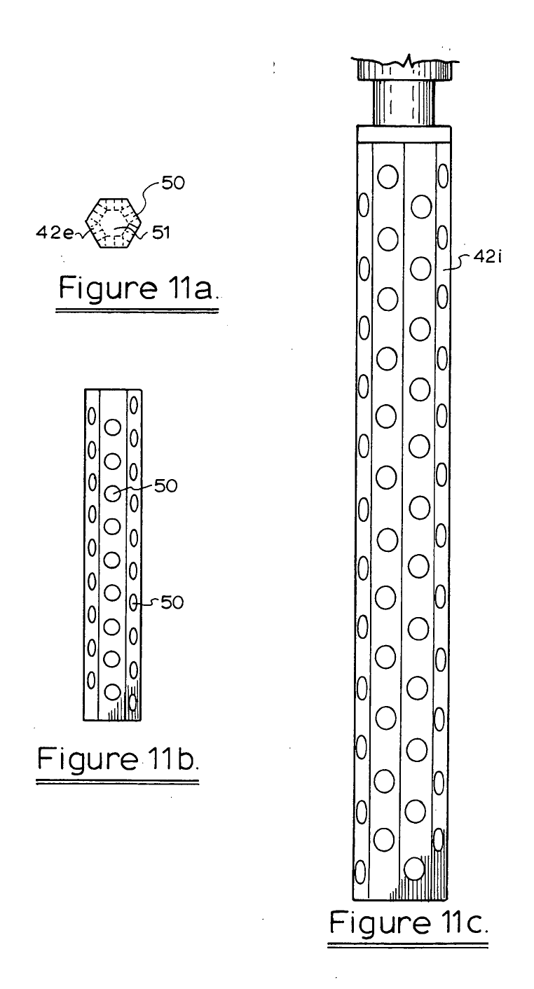

FIG. 4a is a perspective view of a fourth embodiment of a brush head;

FIG. 4b is a side view of a head shaft component;

FIG. 4c is a side view of the brush head shown in FIG. 4a;

FIG. 4d is a side view of the toothbrush with a guard;

FIG. 4e is a detailed view of the toothbrush that has a hood;

FIG. 5a is a perspective view of a fifth embodiment of a brush head;

FIG. 5b is a side view of a head shaft component;

FIG. 5c is a side view of the brush head shown in FIG. 5a;

FIG. 5d is a side view of the toothbrush with a guard;

FIG. 5e is a detailed view of the toothbrush that has a hood;

FIG. 6a is a perspective view of a sixth embodiment of a brush head;

FIG. 6b is side view of the brush head shown in FIG. 6a;

FIG. 6c is a detailed view of the brush head shown in FIG. 6a;

FIG. 6d is a detailed view of the brush head shown in FIG. 6a;

FIG. 7a is a detailed view of a seventh embodiment of a brush head;

FIG. 7b is a detailed view of an eight embodiment of a brush head;

FIG. 7c is a detailed view of a ninth embodiment of a brush head;

FIG. 7d is a detailed view of a tenth embodiment of a brush head;

FIG. 8a is a cross-sectional view of the sixth embodiment of the brush head shown in FIG. 6a;

FIG. 8b is a cross-sectional view of the sixth embodiment of the brush head shown in FIG. 7b;

FIG. 8c is a cross-sectional view of the sixth embodiment of the brush head shown in FIG. 7d;

FIG. 8d is a cross-sectional view of a brush head with polishing heads located in apertures formed in the head shaft;

FIG. 9 is a cross-sectional side view of an eleventh embodiment of a brush head;

FIG. 10a is a perspective view of a portion of a second embodiment of a head shaft;

FIG. 10b is a perspective view of a portion of a third embodiment of a head shaft;

FIG. 10c is a perspective view of a portion of a fourth embodiment of a head shaft;

FIG. 10d is a perspective view of a portion of a fifth embodiment of a head shaft;

FIG. 11a is an end view of a sixth embodiment of a head shaft;

FIG. 11b is a side view of the head shaft shown in FIG. 11a; and

FIG. 11c is a side view of a seventh embodiment of a head shaft.

### DETAILED DESCRIPTION

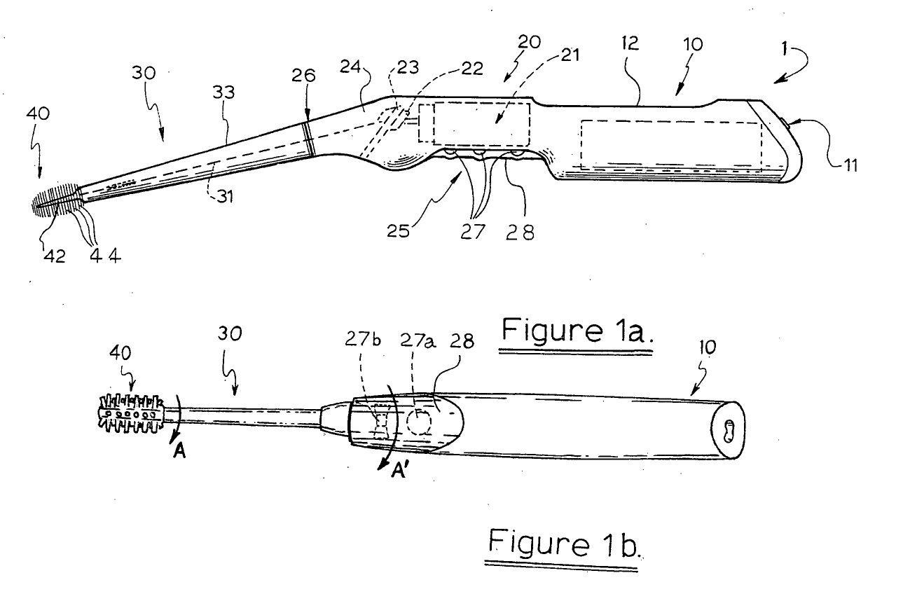

Referring to FIG. 1a, there is shown an electric toothbrush (1) having a handle (10), a motor and gear housing (20) and an attachment (30) comprising an elongate drive shaft (31) and a brush head (40) which provides multiple tooth engaging elements (44). The brush head (40) may optionally include an end cap (not shown) to cover the brush head (40) when not in use.

At the base of the handle (10) are battery recharging terminals (11) adapted to sit in a recharging module as is well known in the art. The battery is a rechargeable nickel-cadmium battery capable of driving a small high speed electric motor (21) housed in the motoring gear housing portion (20). The motor is capable of rotating at about 6000 revolutions per minute (rpm). Accordingly, to adapt the motor (21) to use in a slow rotating brush head device according to the present invention, gear reduction is provided in the form of a small gear (22) operably engaged to a large gear (23), each gear (22, 23) of bevelled configuration to co-operate with each other. At the top of the housing (20) is a small bend whereby to extend the attachment (30) at an angle relative to the longitudinal rotational axis of the motor (21). For this purpose, a universal joint (24) is provided between the gears (23, 22) and the drive shaft (31). The optimum angle is about 12°.

The handle (10) and motor and gear housing (20) are formed from a unitary piece by injection moulding. The handle includes a slight recess (12) to receive the palm of a user's hand and a second control panel recess (25) at which is located a control panel including stop, forward and reverse buttons (27). The control buttons (27) are preferably enveloped in a flexible plastic film or cover (28) to waterproof the internal spaces of the housing (20) against ingress of water. The control panel recess (25) allows the user to use a thumb to operate the control buttons (27) and so to control the toothbrush (1).

The control buttons (27) in FIG. 1a are shown arranged in a line in the longitudinal direction. However, in FIG. 1b the control buttons comprise a stop button (27a) for starting and stopping the motor, and a direction control button (27b) which can be rocked to left or right to switch the rotational direction between clockwise and counter clockwise. For brushing the teeth, the recommended direction is always away from the gums and towards the distal ends of the teeth. Therefore, for brushing the teeth of the upper jaw the rotational direction of the head (40) is such that the tooth engaging elements (44) are travelling downwardly when engaging the teeth. The direction control button (27b) may be rocked in that direction to cause the desired rotational direction of the head (40) as shown by arrows A, A′ so that there is a mnemonic feature assisting the user. The opposite brushing directions are used for teeth of the lower jaw. Instead of rocking switch button 27b , two laterally adjacent individual rotation direction control switches can be used to provide the same mnemonics.

The attachment (30) in FIG. 1a is releasably engaged to the neck (26) of the housing by a snap-fit mechanism, such as deflectable tabs.

The drive shaft (31) is housed in a sheath (32) having an elongate conical shape which is widest at its base (32) where it engages the housing neck (26) and tapers towards the brush head (40). To counteract vibration in the drive shaft (31), there is provided a counter-balance (33).

Although the brush head (40) is manufactured separately from the drive shaft (31) and sheath (33), these components are assembled in a non-reversible manner to reduce the potential for a choking hazard, particularly with regard to the brush head (40). The drive shaft (31) extends into the housing (20) and releasably engages the universal joint (24). At the brush head (40) end of the drive shaft (31), the brush head includes a head shaft (42) which directly connects to that end of the drive shaft (31).

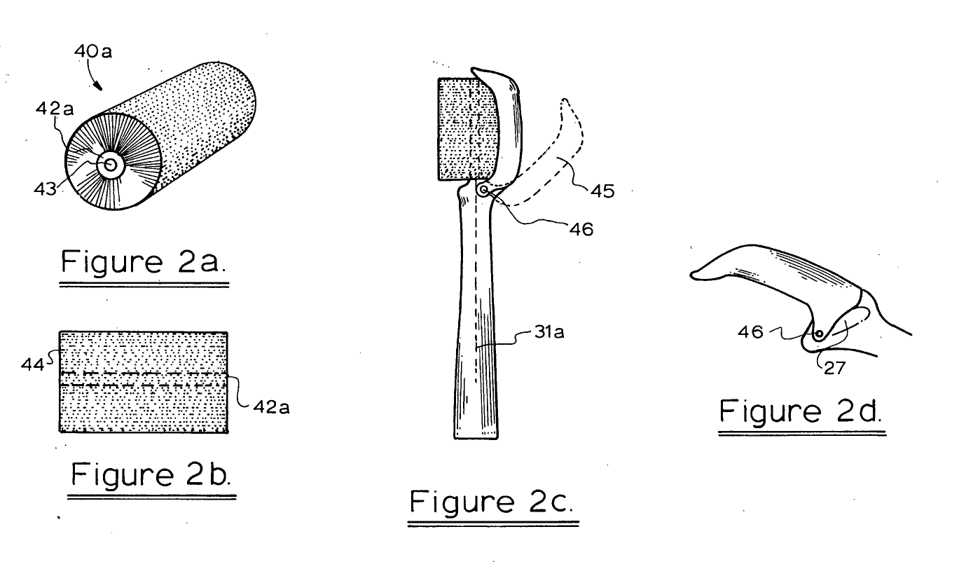

Turning to FIGS. 2a-2d, there is shown a brush head (40a) comprised of a cylinder formed from a high density of bristles (44) radiating from a head shaft (42a). In particular, FIG. 2a shows the head shaft (42a) as including an aperture (43) adapted to receive a corresponding protrusion from a drive shaft (31a).

As shown in FIG. 2c, this embodiment includes a tiltable and removable guard (45) hinged to the housing neck (26) by standard means of a protrusion and aperture combination (46). As shown in FIG. 2d, the housing neck (26) includes a water cleaning duct (27) to enable the brush head (40a) to be cleaned. The guard (45) includes a hood (46) to cover a portion of the top of the brush head (40a) to improve the user's comfort and prevent damage to soft buccal cavity tissue.

In FIGS. 3a-3d, there is shown another embodiment in which the head shaft (42b) is hexagonal in cross-section and the bristles (44b) radiate from the head shaft (42b). The bristles (44b) are arranged in six longitudinal rows corresponding to the six elongate faces of the head shaft (42b). Otherwise, the operation of the embodiment shown in FIGS. 3a-3d is substantially the same as that of the embodiment shown in FIGS. 2a-2d.

In FIGS. 4a-4e there is shown a brush head (40c) having six radiating rows of bristles (44c) in the same manner as those shown in FIGS. 3a-3c. However, to increase user comfort, the ends of each row of bristles (44c) is tapered to present a smoother surface to the buccal cavity of the user. The head shaft (42c) can also be seen to taper at its respective ends to limit the discomfort caused by short bristles made relatively inflexible by their limited length.

FIGS. 5a-5e show a brush head (40d) in which the rows of bristles are more numerous than those shown in FIG. 4a and are more densely packed whereby to provide a cylindrical brush head similar to that of FIG. 2a, except that the respective ends of the brush head and corresponding head shaft (42d) are tapered.

FIGS. 6a-6d show various brush head configurations (40e-40h) in which the head shaft (42e-42h) is hexagonal in cross-section in each case. The bristles (44e-44h) may be single elements about 1 mm in diameter or may represent tufts of bristles as is standard in the art. Preferably, the bristles (44e-44h) are single piece elongate elements made from a soft but resilient polymer such as may be obtained from DuPont, i.e. Tienex® filaments. Preferably, in each case the filaments (44e-44h) taper towards the ends of the head shaft (42e-42h) but the head shaft (42e-42h). comprises a constant hexagonal cross-section throughout its length.

Turning to FIG. 7b there is shown a drive shaft (42i) of octagonal cross-section and bearing eight corresponding flat elongate surfaces from which eight rows of filaments or bristles (44i) radiate. To facilitate a more thorough cleaning action, every alternate row of bristles (44i) is inclined to the normal relative to the longitudinal axis of the head shaft (42i) so that opposed rows on either side of the brush head (40i) are inclined in one direction (in the drawing upwardly) to an angle of inclination of 10° (see rows 45a-b) and the alternately inclined opposed rows (46a, b) are slightly inclined in the other direction (in the drawing downwardly) at an angle of inclination of about 10° also. This variation in the inclination of the bristles (44i) enhances the cleaning action of the brush head (40i).

With reference to FIGS. 7a, 7cand 7d, in alternate arrangements every alternate row of bristles is substituted with a row of polishing elements (47a, c, d). These polishing elements 47a, c, d are made from soft rubber or polymeric material in contrast to the nylon material of which the bristles are typically comprised. The rubber polishing elements (47a, c, d) are universally locatable in the 1 mm apertures but they include divergent elements (47c) as shown in FIGS. 7c presenting a “X” shaped top face being the termination of four diverging arms extending from a cylindrical base. The “X” shaped head of the polishing elements (47c) facilitates the penetration of the edges of the polishing elements (47c) into crevices and gaps in the user's teeth which would otherwise be inaccessible. In a slight variation, the polishing elements (47d) shown in FIG. 7d are of substantially constant “X” shaped cross-section and are locatable in key ways formed in rows of the head shaft (42j).

Referring to FIG. 8a, the end view of a brush head (42e) also shown in FIG. 6a is schematically represented. The bristles (44e) are shown to be aligned in six straight rows. In an alternate embodiment, the rows of apertures on the head shaft may be formed in a spiral pattern whereby to provide greater variation in the approach of the bristles to the user's teeth to facilitate an improved clean and/or polishing performance.

In FIG. 8b, the embodiment also shown in FIG. 7b is shown in end view to illustrate that the rows of bristles (44i) are aligned in straight rows. It will be appreciated that the rows may be spirally formed to provide another variation in the approach of the bristles as they rotate on the brush head (40i).

Turning to FIG. 8c, the polishing elements (47d) also shown in FIG. 7d are shown to be locatable in V-shaped elongate recesses (48) located in between four equally spaced rows of bristles mounted on the head shaft (42j). The head shaft (42j) is of constant “X” shaped cross-section throughout its length.

Referring to FIG. 8d, the polishing elements (47) may be simply locatable in the 1 mm apertures formed in rows on a hexagonal cross-sectioned head shaft (42k).

In FIGS. 10a-10d, there are shown various key way configurations for locating the polishing elements (47). In each case, the polishing elements (47) will include corresponding male or female portions to complement the key way shapes shown. The polishing elements may be press fit into the key ways (49) or may be slid from one end in depending o the resilience of the respective materials and the type of engaging arrangement.

FIG. 11a shows a cross-section of a hexagonal head shaft (42e) showing that the apertures for receiving the bristles and/or polishing elements may extend from the outer flat surface of each side of the head shaft (42e) through to a central bore (51). The central bore (51) may be used to co-operate with a complementary hexagonal shaped drive shaft (31e). FIG. 11b shows the head shaft (42e) in greater detail, including the apertures (50) formed therein.

FIG. 11c is a schematic drawing showing the apertures (50) formed in an octagonal shaped head shaft (42i) similar to that shown in FIG. 7b. Of course, where the bristles (44i) are inclined, the aperture (50) will correspondingly be inclined to the normal.

In another preferred arrangement, there is provided an automatic means for reversing the rotational direction of the brush head as the user changes the toothbrush from one side of the mouth to the other. The reverse direction means may include an inertia or gravitational toggle switch which either acts on reversible gears or on the motor to reverse its direction of rotation. Inertia and gravitational toggle switches are commercially available as modular units from electrical retailers, and the person skilled in the art will appreciate that small scale switches are preferable to ensure that the toothbrush unit remains lightweight and easy to manipulate.

The recommended direction for brushing of teeth is away from the gums and towards the distal or free ends of the teeth, and the present invention provides a rotary toothbrush having a reversible drive direction so that the user can switch the direction of rotation so that the recommended direction of brushing is being used when brushing the user's teeth. However, it is inevitable that users will sometimes apply the rotating brushing head to teeth in a manner that the direction of rotation is opposite to the recommended direction. That is, the user will be brushing teeth in a direction away from the distal or free ends of the teeth and towards the gums. With known high speed oscillating electric toothbrushes or with previously proposed rotary toothbrushes (although no such rotary toothbrushes are known to have been successfully or widely produced and marketed), the speed of oscillation or rotation would be likely to give users significant problems associated with abrading irritating or pushing gums away from the teeth. For example, this can lead to microbial infections beneath the gums with consequent infection, inflammation, discomfort or distress caused by teeth and/or gum sensitivity in the exposed or disturbed areas. It has been surprising found, however, that using the very low rotational speeds taught by the present invention can eliminate or at least substantially remove the problems associated with brush movement direction against the gums in a direction away from the distal free ends of the teeth. The speed of rotation of the brushing head in the present invention is sufficiently low that the gums are not pushed back from the teeth in use.

Previously in this specification a preferred speed range of 60 to 240 rpm has been mentioned. It has been found that the optimal rotation speeds are less than 200 rpm. It has been found that higher speeds in the preferred range still have a tendency to dislodge and throw particles centrifugally away from the rotating brush head. A particularly preferred speed range is within the lowest third of the preferred speed range of 60 to 240 rpm, i.e. from 60 rpm up to about 150 rpm. A preferred optimal speed is about 100 rpm to minimise the centrifugal displacement and discharge of particulates while still achieving effective cleaning action and achieving the benefit of avoiding or minimising pushing of the gums back from the teeth if the rotating brush head is applied to teeth in the opposite direction to the recommended direction. Speeds towards the lower end of the preferred range of 60-240 rpm and even below the lower limit of that range can still effectively clean teeth but because the process is slower users may have a tendency to discontinue brushing before effective cleaning has occurred.

It has been found that there may be a significant psychological resistance or scepticism of users concerning the slow rotational speeds provided in the present invention. In fact, it is believed that there is a strong tendency of users seeing a tooth brushing head operating at a rotational speed of about 100 rpm to believe that speed will not be effective to clean teeth. It is surprising therefore and an unexpected result that a brush head rotational speed of in the order of 100 rpm and preferably no more than about 150 rpm is optimal for effective cleaning while simultaneously avoiding or minimising any injurious action associated with pushing of gums back from the teeth if the rotating brush head is applied so that the rotation direction is opposite to the recommended direction of brushing away from the gums and towards the distal or free ends of the teeth.

In another aspect of the present invention, therefore, there is provided a method of cleaning a user's teeth, the method comprising providing an electric toothbrush (1) having a handle (10) having a drive (21, 22, 23) therein, switch means (27) for controlling the operation of the drive, and a driveable toothbrush attachment (30) extending outwardly and away from the handle in a longitudinal direction, the attachment including a brush head (40) having a plurality of tooth engaging elements (44). The brush head (40) is driven by the drive within the handle so as to rotate about an axis substantially corresponding to the longitudinal axis of the attachment.

The brush head (40) is applied to the user's teeth and the user operates the switch means (27) to power the drive (21, 22, 23) within the handle so that the drive rotates the brush head (40) at a rotational speed sufficiently low so as to avoid the teeth engaging elements (44) pushing the user's gums backwardly from the teeth if the brush head is applied to the user's teeth with the rotational direction being from the distal or free ends of the teeth and towards the gums, that rotational speed being in the range 60 and 240 rpm. As mentioned above, the preferred rotational speed is in the range of 60 to about 150 rpm, and most preferably about 100 rpm.

The user operates the switch means to reverse the direction of rotation upon discontinuing brushing teeth at one side of the mouth and upon moving the toothbrush to apply the brush head to teeth of the same jaw at the other side of the mouth. The user also operates the switch means to reverse the direction of rotation upon discontinuing brushing teeth at one side of the mouth and moving the toothbrush to apply the brush head to teeth of the other jaw at the same side of the mouth. These direction reversals keep the direction of brushing of the teeth engaging elements from the gums towards the distal or free ends of the teeth.

While the present invention has been described in accordance with preferred compositions and embodiments, it is to be understood that certain substitutions and alterations may be made thereto without departing from the spirit and scope of the following claims.

1. An electric toothbrush having a handle with a drive therein, switch means for controlling operation of the drive, and a driveable toothbrush attachment, comprising: a brush head having a plurality of tooth engaging elements, the brush head being located and coupled to an elongate drive shaft which is operably associated with the drive so as to be drivingly rotated thereby, wherein the drive operates to rotate the brush head at a rotational speed of between 60 and 240 revolutions per minute (rpm.) about an axis substantially corresponding to the longitudinal axis of the drive shaft.

2. The toothbrush of claim 1 wherein the rotational speed of the brush head is between 60 and about 150 rpm.

3. The toothbrush of claim 2 wherein the rotational speed of the brush head is about 100 rpm.

4. The toothbrush of claim 1, wherein the tooth engaging elements include a combination of polishers as well as bristles.

5. The toothbrush of claim 4, wherein the bristles and polishers are located in alternating rows aligned parallel to the longitudinal axis of the brush head.

6. The toothbrush of claim 4, wherein the brush head includes a central head shaft and the bristles and polishers extend outwardly from the head shaft.

7. The toothbrush of claim 4, wherein the polishers include edges which facilitate the penetration of the polishers into crevices or gaps in the user's teeth.

8. The toothbrush of claim 4, wherein the polishers are made from soft rubber or polymeric material.

9. The toothbrush of claim 7, wherein at least one of the polishers is X-shaped in cross-section.

10. The toothbrush of claim 1, wherein the brush head includes a central head shaft which is tapered at one or both ends to permit corresponding tapering by the tooth engaging elements at the or each tapered end.

11. The toothbrush of claim 1, wherein the attachment is adapted for connection to toothbrush drive means having a gravitational toggle switch which effectively reverses the direction of rotation of the head shaft depending on the left-handed or right-handed orientation of the toothbrush.

12. A method for making a driveable toothbrush attachment, comprising:
a) inserting a plurality of tooth engaging elements in recesses formed therefor in a head shaft to form a brush head; and
b) operably engaging the head shaft to an elongate drive shaft, wherein the brush head is operable to rotate at a speed of between 60 and 240 revolutions per minute (rpm) about an axis substantially corresponding to the longitudinal axis of the drive shaft.

13. The method of claim 12, wherein step a) further comprises the step of:
i) moulding the head shaft polygonal in cross-section whereby to present a plurality of rows of recesses along each face of the polygon.

14. The method of claim 13, wherein step a) further comprises the steps of:
ii) forming recesses in the form of rows of cylindrical bores in the external surface of the head shaft, the bores generally radiating from the longitudinal axis thereof; and
iii) inserting rows of bristles alternating with rows of polishers in the bores.

15. The method of claim 14, wherein the recesses formed in step ii) are set at an oblique angle relative to the longitudinal axis of the head drive whereby the tooth engaging elements are inclined to the normal relative to the surface of the head shaft.

16. A method of cleaning a user's teeth, the method comprising: providing an electric toothbrush with a handle having a drive therein, switch means for controlling the operation of the drive, and a driveable toothbrush attachment extending outwardly and away from the handle in a longitudinal direction, the attachment including a brush head having a plurality of tooth engaging elements, the brush head being driven by the drive within the handle so as to rotate about an axis substantially corresponding to the longitudinal axis of the attachment, applying the brush head to the user's teeth, and operating the switch means to power the drive within the handle so that the drive rotates the brush head at a rotational speed sufficiently low so as to avoid the teeth engaging elements pushing the user's gums backwardly from the teeth if the brush head is applied to the user's teeth with the rotational direction being from the distal or free ends of the teeth and towards the gums, that rotational speed being in the range 60 and 240 rpm.

17. The method of claim 16 wherein the rotational speed of the brush head is between 60 and about 150 rpm.

18. The method of claim 17 wherein the rotational speed of the brush head is about 100 rpm.

19. The method of claim 16 further comprising the step of operating the switch means to reverse the direction of rotation upon discontinuing brushing teeth at one side of the mouth and moving the toothbrush to apply the brush head to teeth of the same jaw at the other side of the mouth.

20. The method of claim 16 further comprising the step of operating the switch means to reverse the direction of rotation upon discontinuing brushing teeth at one side of the mouth and moving the toothbrush to apply the brush head to teeth of the other jaw at the same side of the mouth.
